(19) United States
(12) Patent Application Publication
(10) Pub. No.: US 2005/0169267 A1
(43) Pub. Date: Aug. 4, 2005

(54) Method and apparatus for securing mobile packet

(75) Inventors: Kyo-shin Choo, Yongin-si (KR); Hak-goo Lee, Suwon-si (KR); Min-jae Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd, Suwon-Si (KR)

(21) Appl. No.: 11/047,641

(22) Filed: Feb. 2, 2005

(30) Foreign Application Priority Data
Feb. 2, 2004 (KR) 2004-6610

(51) Int. Cl. H04L 12/28

(52) U.S. Cl. 370/389

(57) ABSTRACT

A method of and apparatus for securing a Mobile lpv6 packet. The method includes: confirming, by a mobile node in an external link, whether an address of the mobile node is registered at a home agent at which a home link of the mobile node is present; and discarding a packet that should be transmitted when it is confirmed that the address is registered.

### CROSS-REFERENCE TO RELATED APPLICATION

This application claims the priority of Korean Patent Application No. 2004-6610, filed on Feb. 2, 2004, in the Korean Intellectual Property Office, the disclosure of which is incorporated herein by reference.

### BACKGROUND OF THE INVENTION

1. Field of the Invention

The present invention relates to a Mobile lpv6 (Internet Protocol version 6) packet, and more particularly to a method and apparatus for securing a Mobile lpv6 packet.

2. Description of Related Art

FIG. 1 illustrates a structure of a conventional Mobile lPv6 network system that includes a mobile node 11, a home agent 12, and a corresponding node 13.

The mobile node 11 refers to a node that can change a point of attachment from one link to another. The home agent 12 refers to a router in which the mobile node 11, which has moved from a home link (link A), registers its current care of address (COA). The home agent 12 exists at the home link (link A) of the mobile node 11. The COA is an address used at link B where the mobile node is currently at. The corresponding node 13 refers to a node, communicating with the mobile node 11.

As shown in FIG. 1, the mobile node 11, which stays at the home link (link A), moves to an external link (link B), stays at the current external link (link B), and communicates with the corresponding node 13 which exists at link C. As illustrated in FIG. 1, when a network prefix of the home link (link A) at which the mobile node 11 has stayed is 3FFE:2E01:2A:201, a network prefix of the external link (link B) at which the mobile node 11 is currently staying is 3FFE:2E01:2A:301, a network prefix of link C (this address is called the Home Address) is 3FFE:2E01:2A:201::1, an address (this address is the COA) of the mobile node 11 which is used at the external link (link B) is 3FFE:2E01:2A:301::1, and an address of the corresponding node 13 which is used at link C is 3FFE:2E01:2A:1010::1.

FIG. 2 illustrates address usage periods, which are categorized according to the types of addresses that the mobile node uses.

Referring to FIGS. 1 and 2, during a period in which a mobile node stays at a home link (link A), a home address 3FFE:2E01:2A:201::1 is used, and communication is carried out in the same manner like for a general node. This period is a home address usage period. Therefore, when starting a communication with a corresponding node 13, an address of the mobile node 11 is the home address 3FFE:2E01:2A:201::1 . When the mobile node 12 moves to an external link (link B) from the home link (link A), the mobile node 12 generates a new COA 3FFE:2E01:2A:301::1, based on a prefix 3FFE:2E01:2A:301 of the external link (link B). The mobile node 11, which detects a movement, transmits a binding update to a home agent 12, which exists at the home link (link A), to register its current COA. The home agent 12, which receives the binding update, transmits a binding acknowledgement, which indicates that the COA is registered. Therefore, a COA, which is not registered at the home agent 12, is used from the time when the binding update is transmitted to the time when the binding acknowledgement is received. A period from the time when the binding update is transmitted to the time when the binding acknowledgement is received is an unregistered COA usage period and a period after the time when the binding acknowledgement is received is a registered COA usage period.

As described above, during the unregistered COA usage period the mobile node 11 uses the unregistered COA to communicate with the corresponding node 13. However, since the corresponding node 13 does not recognize a COA which is not registered at the home agent 12 as the new address of the mobile node 11, the corresponding node 13 recognizes the home address 3FFE:2E01:2A:201::1 , which is the address of the mobile node 11 when the communication started with the corresponding node 13, as the address of the mobile node 11. This situation includes cases in which the mobile node 11 moves from a home link to an external link and cases in which the mobile node 11 moves to another external link from the external link. In the latter, with respect to the above example, the home address is the COA of the external link, where the mobile node 11 has was at. If a secured channel is configured between the home address 3FFE:2E01:2A:201::1 of the mobile node and the address 3FFE:2E01:2A:100::1 of the corresponding node, the two communicate through a secured channel. However, the secured channel is not yet configured between the unregistered COA 3FFE:2E01:2A:301::1, and the address 3FFE:2E01:2A:100::1 of the corresponding node 13. Therefore, the corresponding node 13 which received a packet that has an unregistered COA as a destination address cannot trust the received packet and discards the packet. Since the packet that is discarded by the corresponding node 13 is transmitted though an unsecured channel, the packet can be accessed by unauthorized persons or even lost.

In addition, in a connection-oriented communication like a transmission control protocol (TCP), abandoned packets are retransmitted. In a connection-less communication such as a user datagram protocol (UDP), abandoned packets are not retransmitted but are ignored. Both cases have the problem of network overload. In other words, in the case of the TCP, the network is overloaded by retransmission, and in the case of the UDP, the network is overloaded due to the ignored packet, that is, due to the transmission of meaningless packets.

Furthermore, when reception of a binding update and/or binding acknowledgement is delayed because a problem occurs in the home agent 12 or the network, the unregistered COA usage period is extended and the problems mentioned above aggravate.

### BRIEF SUMMARY

An aspect of the present invention provides a device and method for preventing a mobile packet from being accessed by an unauthorized person or lost during transmission.

According to an aspect of the present invention, there is provided a method of securing packets, including: confirming, by a mobile node in an external link, whether an address of the mobile node is registered at a home agent at which a home link of the mobile node is present; and discarding a packet that should be transmitted when it is confirmed that the address is registered.

According to another aspect of the present invention, there is provided a device for securing packets, including: a home registration confirmer confirming whether a mobile node that is at an external link registers an address of the mobile node at a home agent at which a home link of the mobile node is present; and a packet discarder discarding the packet that should be transferred when the address is confirmed to be registered.

According to another aspect of the present invention, there is provided a method of securing packets to be received, including: receiving a packet; confirming whether a care of address (COA) is registered at a home agent; confirming whether a received packet is a binding acknowledgement; configuring the COA as not registered when registration of the COA at the home agent and that the receiving packet is a binding acknowledgement are confirmed; and processing the received packet when the COA is configured as not registered, the received packet is confirmed not to be a binding acknowledgement, or when the COA is confirmed not to be registered.

According to still other aspects of the present invention, there are provided computer readable recording media having recorded thereon a program for executing the aforesaid methods.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 illustrates a structure of a conventional Mobile lPv6 network system;

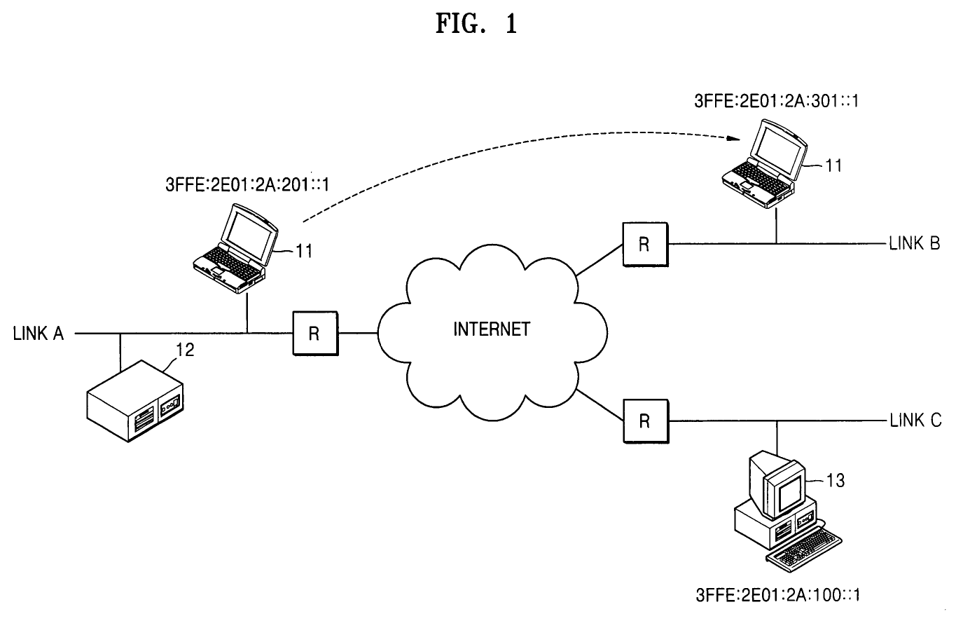

FIG. 2 illustrates address usage periods, which are categorized according to the types of addresses which are used by mobile nodes of the system of FIG. 1;

FIG. 3 illustrates an example of a structure of the Mobile lPv6 network system in which a device for securing packets according to an embodiment of the present invention is applicable;

FIG. 4 is a flowchart of a method for securing packets to be received according to an embodiment of the present invention; and

FIG. 5 is a flowchart of a method of securing packets to be transmitted according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

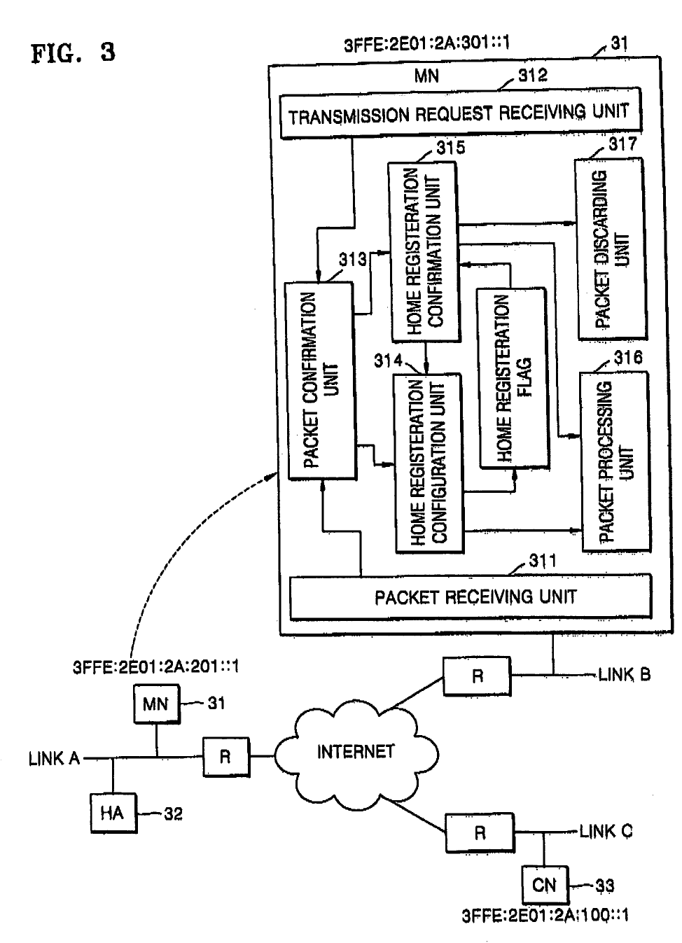

FIG. 3 illustrates a structure of a Mobile lPv6 network system in which a device for securing packets is applied according to the embodiment of the present invention.

Referring to FIG. 3, the Mobile lPv6 network system includes a mobile node (MN) 31, a home agent (HA) 32, and a corresponding node 33. The device for securing packets according to the present embodiment can be loaded onto the mobile node 31, especially, an IP layer of the mobile node.

As shown in FIG. 3, the mobile node 31, which stayed at a home link (link A), moves to an external link (link B), is currently present at the external link (link B), and communicates with the corresponding node 33 which exists at link C. As shown in FIG. 3, when a network prefix of the home link (link A), which the mobile node 31 was at, is 3FFE:2E01:2A:201::1, a network prefix of the external link (link B) at which the mobile node 31 is currently staying is 3FFE:2E01:2A:301, a network prefix of link C is 3FFE:2E01:2A:100::1. An address (the home address) of the mobile node 31 which is used at the home link (link A) is 3FFE:2E01:2A:201, an address (a COA) of the mobile node 31 used at the external link (link B) is 3FFE:2E01:2A:301::1, and an address of the corresponding node 13 used at link C is 3FFE:2E01:2A:100::1.

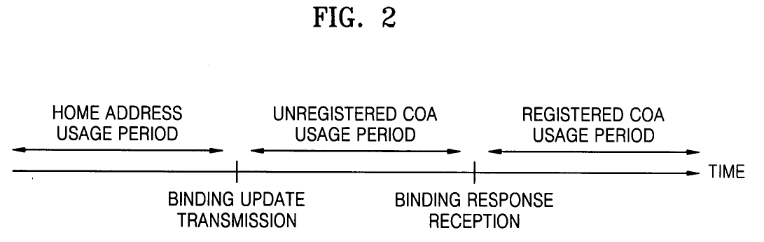

When transmitting a packet which has the COA 3FFE:2E01:2A:301::1 as a source address in which the mobile node 31 is not registered at during an unregistered COA usage period as shown in FIG. 2, the device for securing packets, which is loaded onto the mobile node 31, blocks the transmission of the packet which has the unregistered COA 3FFE:2E01:2A:301::1 to the source address to prevent the transmitted packet being accessed or lost.

Referring to FIG. 3, the device for securing packets includes a packet receiver 311, a packet confirmer 313, a home registration confirmer 315, a home registration configuration unit 314, a packet processor 316, a transmission request receiver 312, and a packet discarder 317.

The packet receiver 311 receives a packet from a lower layer positioned at a lower portion of an IP layer, for example, a link layer. The packet is received from the corresponding node 33 via link C, the Internet, and link B (the packet goes through routers placed along a transmission path). The transmission request receiver 312 receives a request to transmit the packet from an upper layer which is placed in an upper portion of the IP layer, for example, a TCP layer or from an inside of IP layer.

The packet confirmer 313 confirms whether the received packet is a binding update so as to confirm whether a current point falls within the unregistered COA usage period when the mobile node 31 receives the packet, that is, when the packet receiver 311 receives the packet as shown in FIG. 2. The binding acknowledgement is a message indicating that the COA 3FFE:2E01:2A:301::1 of mobile node 31 is registered at the home agent 32, and the unregistered CO usage period is shown up to the point before the binding acknowledgement is received.

In addition, the packet confirmer 313 confirms whether a destination of the packet, which should be transmitted, is within the external link (link B) at which the mobile node 31 is currently present, and confirms whether the packet that should be transmitted is a binding acknowledgement to confirm whether it is alright for the packet that should be transmitted to be transmitted to the outside when the mobile node 31 transmits a packet, that is, when the transmission request receiver 312 receives a request to transmit a packet. When the destination of the packet that should be transmitted is within the external link (link B) at which the mobile node 31 is currently present, since there is not a possibility that it will be exposed to unspecified persons on the Internet, it is alright to transmit the packet without taking any specific measures. An example of such a packet is neighbor discovery, neighbor solicitation, neighbor advertisement, router solicitation, and router advertisement etc. are types of neighbor discovery. In addition, since such a packet contains information essential to perform operations within a link, transmission should not be blocked. Furthermore, when the packet that should be transmitted is a binding update, it is alright if the information, which is included in the binding update, is accessed or lost and this information is essential for registering COA 3FFE:2E01:2A:301::1 at the home agent 32 or updating another COA and should not be blocked. Especially, the packet confirmer 313 confirms the packet that should be transmitted as a binding update and it confirms whether the packet is an initial binding update to confirm whether the current point of the binding update falls within the unregistered COA usage period shown in FIG. 2. The initial binding update is a message to register the COA 3FFE:2E01:2A:301::1 of the mobile phone at the home agent 32 and from the point after transmitting the binding update is the unregistered COA usage duration as shown in FIG. 2.

The home registration configuration unit 314 configures the COA 3FFE:2E01:2A:301::1 as not being registered by the home agent 32 when it is confirmed that COA 3FFE:2E01:2A:301::1 is not registered at the home registration confirmer 315, and the received packet is confirmed to be a binding acknowledgement by the packet confirmer 313.

The home registration configuration unit 314 configures the COA 3FFE:2E01:2A:301::1 as being registered at the home agent 32 when the packet confirmer 313 confirms that the packet, which should be transmitted, is an initial binding acknowledgement. According to the present embodiment, the home registration configuration unit 314 can configure the COA 3FFE:2E01:2A:301::1 as not being registered by recording a value that indicates that COA 3FFE:2E01:2A:301::1 is not being registered at the home registration flag, for example 0, and can configure COA 3FFE:2E01:2A:301::1 as being registered by recording a value that indicates COA 3FFE:2E01:2A:301::1 is being registered at the home registration flag, for example, 1.

The home registration confirmer 315 confirms whether COA 3FFE:2E01:2A:301::1 is registered at the home agent 32 when the packet is received at the packet receiver 311 or it is confirmed that the destination of the packet that should be transmitted by the packet confirmer 313 is not present within the external link (link B) and when it is confirmed that the packet that should be transmitted is not a binding update. The home registration confirmer 315 makes a confirmation on the basis of the configuration of the home registration configuration unit 314. In other words, the confirmation is made considering the home registration flag in which the value indicating whether COA 3FFE:2E01:2A:301::1 is registered is recorded.

The packet processor 316 transmits the obtained data to the upper layer by processing the received packet according to the IP or transmits the packet that should be transmitted to the lower layer form of an IP packet by processing it according to the IP. When it is confirmed by the packet confirmation unit 313 that a destination of the packet that should be transmitted is not present within the external link (link B), the packet is confirmed to be a binding update or the COA 3FFE:2E01:2A:301::1 is confirmed as not being registered at the home registration confirmation unit 315, and the pack processing unit 316 can relay the packet to a lower layer.

The packet discarder 317 discards the packet that should be transmitted when it is confirmed by the packet confirmer 313 of the packet that should be transmitted that the destination of the packet is not present within the external link (link B) or the packet is confirmed to be a binding update or when it is confirmed that COA 3FFE:2E01:2A:301::1 is not registered at the home registration confirmer 315.

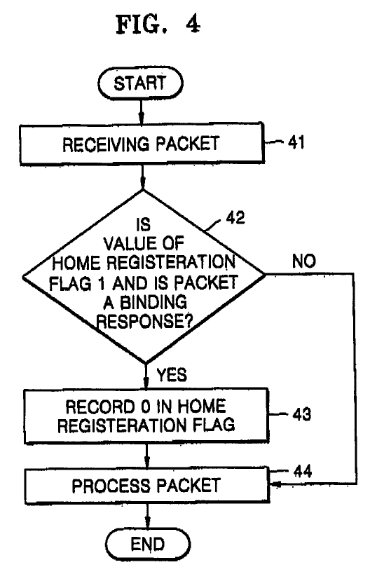

FIG. 4 is a flowchart of a method for securing packets to be received according to an embodiment of the present invention, which includes the following operations. The method of FIG. 4 is explained with concurrent reference to FIG. 3.

First, the packet receiver 311 receives a packet at operation 41. Next, the home registration confirmer 315 confirms whether a COA is registered at the home agent 32. In other words, the home registration confirmer 315 confirms whether the value recorded at the home registration flag is 0. At the same time, the packet confirmer 313 confirms whether the received packet is a binding acknowledgement at operation 42. Next, if the value recorded at the home registration flag is confirmed to be 1 by the home registration confirmer 315 and the received packet is confirmed to be a binding acknowledgement by the packet confirmer 313, the home registration configuration unit 314 configures the COA as not registered at operation 43. In other words, the home registration configuration unit 314 records 0 at the home registration flag. Next, the packet processor 316 processes the received packet when the value recorded at the home registration flag by the home registration confirmer 315 is 0 or it is confirmed that the received packet is not a binding acknowledgement by the packet confirmer 313 or when 0 is recorded at the home registration flag by the home registration confirmer 314.

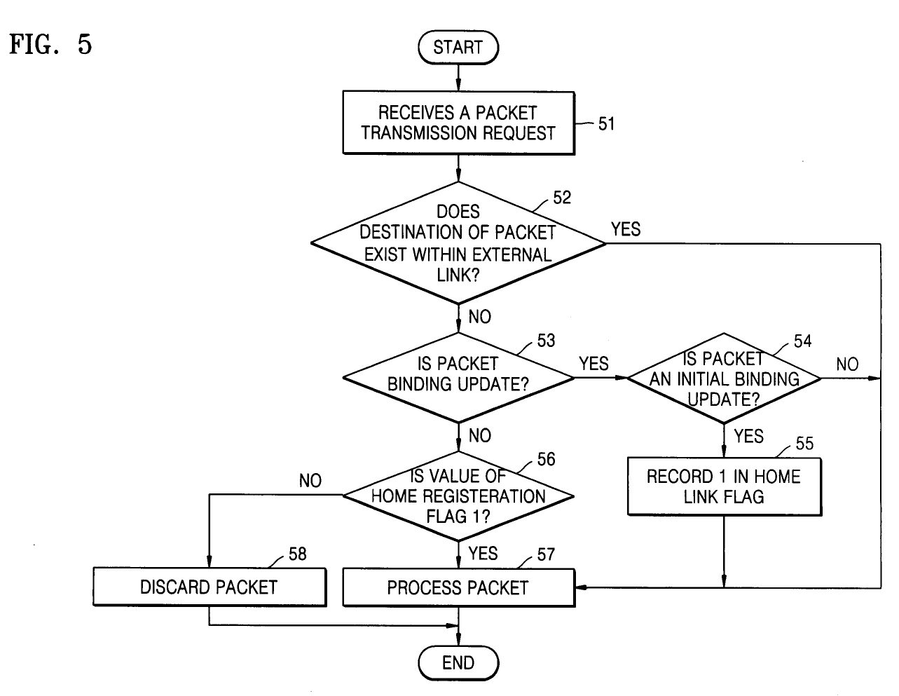

FIG. 5 is a flowchart of a method for securing packets to be transmitted according to an embodiment of the present invention, which includes the following operations. The method of FIG. 5 is explained with reference to FIG. 3

First, the transmission request receiver 312 receives a request to transmit a packet at operation 51. Next, the packet confirmer 313 confirms whether a destination of the packet that should be transmitted is within the external link (link B) at operation 52. Next, if it is confirmed by the packet confirmer 313 that the destination of the packet is not present within the external link (link B) the packet confirmer 313 confirms whether the packet that should be transmitted is a binding update at operation 53. Next, if it is confirmed that the packet that should be transmitted is a binding update the packet confirmer 313 confirms whether the binding update is an initial binding update at operation 54. Next, if it is confirmed by the packet processor 314 that the binding update is an initial binding update, COA is configured as registered at the home registration configuration unit 314 at operation 55. In other words, the value 1 is recorded at the home registration flag.

Next, if it is confirmed that the packet that should be transmitted is not a binding update, the home registration confirmer 314 confirms whether the COA is registered at the home agent 32 at operation 56. In other words, the home registration confirmer 314 confirms whether the value recorded at the home registration flag is 1. Next, the packet processor 316 processes the packet that should be transmitted when it is confirmed that the destination of the packet that should be transmitted is within the external link (link B) or it is confirmed by the packet confirmer 313 that the binding update is not an initial binding update or the COA is configured to be registered by the home registration configuration unit 314 at operation 57. In addition, when it is confirmed by the home registration confirmer 314 that the COA is not registered, that is, when the value recorded at the home registration flag is 0, the packet processor 316 processes a packet that should be transmitted.

When it is confirmed by the home registration confirmer 314 that the COA is registered, the packet discarder 317 discards a packet that should be transmitted at operation 58.

The above-described embodiments of the present invention can be realized as a code on a recording medium readable by a computer. The recording medium, which a computer can read includes all kinds of recording devices which store data that can be read by a computer system. ROM, RAM, CD-ROMs, magnetic tapes, hard disks, floppy disks, flash memory, and optical data storing devices are examples of the recording medium. The recording medium can also be in a carrier wave form (for example, transmission through the Internet). Furthermore, the recording medium can be accessed from a computer in a computer network, and the code can be stored and executed in a remote method.

According to the above-described embodiments of the present invention, by blocking the transmission of a packet that has an unregistered COA as a source address the exposure or loss of a packet to unspecified persons through an unsecured channel can be prevented. In other words, the above-described embodiments of the present invention can guarantee the security of a packet during the registration of the COA at a home agent. Furthermore, the above-described embodiments of the present invention can reduce network overload by reducing the retransmission of a packet in a connection-oriented communication such as TCP and by not transmitting a packet that would be ignored in a connectionless communication such as UDP.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method of securing packets, comprising:
confirming, by a mobile node in an external link, whether an address of the mobile node is registered at a home agent at which a home link of the mobile node is present; and
discarding a packet that should be transmitted when it is confirmed that the address is registered.

2. The method of claim 1, wherein the address is a care of address (COA) of the mobile node, which is used at the external link, among the addresses of the mobile node.

3. The method of claim 1, wherein a period of registering the address is from when the mobile node transmits a binding update to register the address to the home agent to when a binding acknowledgement indicating that the address has been registered is received from the home agent.

4. The method of claim 1, wherein the confirming refers to a home registration flag at which a value, indicating whether the address is registered, is recorded.

5. The method of claim 1, further comprising:
confirming whether a destination of the packet that should be transmitted is within the external link,
wherein the confirming confirms whether the address is registered, when it is confirmed that the destination is not present at the external link.

6. The method of claim 1, further comprising:
confirming whether the packet that should be transmitted is a binding update for updating the address of the mobile node at the home agent,
wherein the confirming confirms whether the address is registered, when it is confirmed that the packet that should be transmitted is not a binding update.

7. The method of claim 6, further comprising:
confirming whether the binding update is an initial binding update for registering the address of the mobile node at the home agent, when it is confirmed that the packet that should be transmitted is the binding update; and
configuring the address as registered when the binding update is confirmed to be the initial binding update,
wherein the confirming is performed on the basis of the configuration.

8. The method of claim 1, further comprising:
confirming whether the packet which is received at the mobile node is a binding acknowledgement indicating that the address is registered at the home agent; and
configuring the address as not being registered when it is confirmed that the received packet is the binding acknowledgement,
wherein the confirming is performed on the basis of the configuration.

9. A device for securing packets, comprising:
a home registration confirmer confirming whether a mobile node that is at an external link registers an address of the mobile node at a home agent at which a home link of the mobile node is present; and
a packet discarder discarding the packet that should be transferred when the address is confirmed to be registered.

10. The device of claim 9, wherein the address is a COA of the mobile node which is used at the external link among the addresses of the mobile node.

11. The device of claim 9, wherein a period of registering the address is from when the mobile node transmits a binding update to register the address to the home agent to when a binding acknowledgement indicating that the address has been registered is received from the home agent.

12. The device of claim 9, wherein the home registration confirmer refers to a home registration flag at which a value is recorded, the value indicating whether the address is registered.

13. The device of claim 9, further comprising:
a packet confirmer confirming whether a destination of the packet that should be transmitted is within the external link,
wherein the home registration confirmer confirms whether the address is registered when it is confirmed that the destination is not present within the external link.

14. The device of claim 9, further comprising:
a packet confirmer confirming whether the packet that should be transmitted is a binding update for updating the address of the mobile node at the home agent; and
wherein the home registration confirmer confirms whether the address is registered when it is confirmed that the packet that should be transmitted is not a binding update.

15. The device of claim 14, wherein the packet confirmer confirms whether the binding update is an initial binding update for registering the address of the mobile node at the home agent when it is confirmed that the packet that should be transmitted is the binding update, further comprising:
a home registration configuration unit configuring the address as registered when the binding update is confirmed to be the initial binding update; and
wherein the home registration confirmer confirms on the basis of the configuration.

16. The device of claim 9, further comprising:
a packet confirmer confirming whether the packet received at the mobile node is a binding acknowledgement indicating that the address is being registered at the home agent; and
a home registration configuration unit which configures the address as not registered when it is confirmed that the received packet is a binding acknowledgement,
wherein the home registration confirmer makes a confirmation on the basis of the configuration.

17. A computer readable recording medium having recorded thereon a program for executing a method of securing packets, the method comprising:
confirming, by a mobile node in an external link, whether an address of the mobile node is registered at a home agent at which a home link of the mobile node is present; and
discarding a packet that should be transmitted when it is confirmed that the address is registered.

18. A method of securing packets to be received, comprising:
receiving a packet;
confirming whether a care of address (COA) is registered at a home agent;
confirming whether a received packet is a binding acknowledgement;
configuring the COA as not registered when registration of the COA at the home agent and that the receiving packet is a binding acknowledgement are confirmed; and
processing the received packet when the COA is configured as not registered, the received packet is confirmed not to be a binding acknowledgement, or when the COA is confirmed not to be registered.

19. The method of claim 18, wherein registration of the COA at the home agent is confirmed when a value recorded at the home registration flag is 1.

20. The method of claim 18, wherein the confirming whether a care of address (COA) is registered at a home agent and the confirming whether a received packet is a binding acknowledgement are performed at the same time.

21. The method of claim 18, wherein, in the configuring, 0 is recorded at the home registration flag.
